(19) United States
(12) Patent Application Publication
(10) Pub. No.: US 2026/0136224 A1
(43) Pub. Date: May 14, 2026

(54) METHOD AND APPARATUS FOR ENHANCED MDT MEASUREMENT FOR UE ASSISTED AI ANALYTICS

(71) Applicant: Samsung Electronics Co., Ltd., Gyeonggi-do (KR)

(72) Inventors: Selcuk BASSOY, Middlesex (GB); Joan PUJOL ROIG, Middlesex (GB)

(21) Appl. No.: 19/168,570

(22) PCT Filed: Apr. 26, 2024
(86) PCT No.: PCT/KR2024/005672

§ 371 Date: Sep. 24, 2025

(30) Foreign Application Priority Data
May 15, 2023 (GB) 2307228.3
Apr. 15, 2024 (GB) 2405316.7

(51) Int. Cl. H04W 24/10; H04L 41/16; H04W 24/08; H04W 76/20

(52) U.S. Cl. CPC H04W 24/10; H04L 41/16; H04W 24/08; H04W 76/20

(57) ABSTRACT

The present disclosure relates to a 5G communication system or a 6G communication system for supporting higher data rates beyond a 4G communication system such as long term evolution (LTE). A wireless communication system (200, 300) comprises: a network entity (242) comprising a transceiver operably coupled to a first signal processor (258) and configured to support wireless communication for at least one wireless communication unit (280). The at least one wireless communication unit (280) comprises: a transceiver (306, 324) operably coupled to a second signal processor (308) and a memory device (316) and the at least one wireless communication unit (280) is configured to: perform radio resource control connected, RRC_CONNECTED state measurements; store the RRC_CONNECTED state measurements in the memory device (316) for a period of time that form a history of RRC_CONNECTED state measurements; and access the memory device (316) and transmit the history of RRC_CONNECTED state measurements to the network entity (242).

### TECHNICAL FIELD

The technical field relates generally to a system, methods and various devices to provide enhanced minimisation of drive test, MDT, measurements in mobile networks. In particular, example implementations include a system, methods and various devices to provide new procedures on a configuration of UEs to log measurements, as well as describing new procedures to update additional information to a network, for example for UE-assisted artificial intelligence (AI) analytics purposes.

### BACKGROUND ART

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present disclosure relates to sidelink FR2 initial beam acquisition.

### Solution to Problem

In a first aspect, a wireless communication system (200, 300) is described that comprises: a network entity (242) comprising a transceiver operably coupled to a first signal processor (258) and operable to support wireless communication for at least one wireless communication unit (280); wherein the at least one wireless communication unit (280) comprises a transceiver (306, 324) operably coupled to a second signal processor (308) and a memory device (316) and the at least one wireless communication unit (280) is operable to: perform radio resource control connected, RRC_CONNECTED state measurements; store the RRC_CONNECTED state measurements in the memory device (316) for a period of time that form a history of RRC_CONNECTED state measurements; and access the memory device (316) and transmit the history of RRC_CONNECTED state measurements to the network entity (242).

In a second aspect, a network entity (242) is described that comprises a transceiver operably coupled to a first signal processor (258) and is operable to support wireless communication for at least one wireless communication unit (280), wherein the transceiver is operable to receive history of RRC_CONNECTED state measurements recorded and stored by the at least one wireless communication unit (280).

In a third aspect, a method for a network entity (242) is described, wherein the method at the network entity (242) comprises receiving a history of RRC_CONNECTED state measurements recorded and stored by the at least one wireless communication unit (280).

In a fourth aspect, a wireless communication unit (280) is described that comprises a transceiver (306, 324) operably coupled to a signal processor (308) and a memory device (316), wherein the signal processor (308) is operable to: perform radio resource control connected, RRC_CONNECTED state measurements; store the RRC_CONNECTED state measurements in the memory device (316) for a period of time that forms a history of RRC_CONNECTED state measurements; and access the memory device (316) and transmit the history of RRC_CONNECTED state measurements to the network entity (242).

In a fifth aspect, a method for a wireless communication unit (280) is described, wherein the method comprises: performing radio resource control connected, RRC_CONNECTED state measurements; storing the RRC_CONNECTED state measurements in a memory device (316) of the wireless communication unit (280) for a period of time that forms a history of RRC_CONNECTED state measurements; and accessing the memory device (316) and transmit the history of RRC_CONNECTED state measurements to the network entity (242).

In a sixth aspect, a wireless communication system (200, 300) is described that comprises: a network entity (242) comprising a transceiver operably coupled to a first signal processor (258) and operable to support wireless communication for at least one wireless communication unit (280); wherein the at least one wireless communication unit (280) comprises a transceiver (306, 324) operably coupled to a second signal processor (308) and is operable to: perform radio resource control connected, RRC_CONNECTED state measurements; and transmit the RRC_CONNECTED state measurements that comprises a Modulation and coding Scheme, MCS, value for downlink and uplink communications for the wireless communication unit (280) using a minimisation of drive test, MDT, procedure to the network entity (242)

In a seventh aspect, a network entity (242) is described that comprising a transceiver operably coupled to a first signal processor (258) and operable to support wireless communication for at least one wireless communication unit (280); wherein the transceiver is operable to receive, from the wireless communication unit (280), RRC_CONNECTED state measurements that comprise a Modulation and coding Scheme, MCS, value for downlink and uplink communications for the wireless communication unit (280) using a minimisation of drive test, MDT, procedure.

In an eighth aspect, a wireless communication unit (280) is described that comprises a transceiver (306, 324) operably coupled to a second signal processor (308), wherein the wireless communication unit (280) is operable to: perform radio resource control connected, RRC_CONNECTED state measurements; and transmit the RRC_CONNECTED state measurements that comprise a Modulation and coding Scheme, MCS, value for downlink and uplink communications for the wireless communication unit (280) using a minimisation of drive test, MDT, procedure to a network entity (242).

In a ninth aspect, a method for a network entity (242) is described that comprising a transceiver operably coupled to a first signal processor (258) and operable to support wireless communication for at least one wireless communication unit (280); wherein the transceiver is operable to receive, from the wireless communication unit (280), RRC_CONNECTED state measurements that comprise a Modulation and coding Scheme, MCS, value for downlink and uplink communications for the wireless communication unit (280) using a minimisation of drive test, MDT, procedure.

In a tenth aspect, a method for a wireless communication unit (280) is described that comprises a transceiver (306, 324) operably coupled to a second signal processor (308), wherein the wireless communication unit (280) is operable to: perform radio resource control connected, RRC_CONNECTED state measurements; and transmit the RRC_CONNECTED state measurements that comprise a Modulation and coding Scheme, MCS, value for downlink and uplink communications for the wireless communication unit (280) using a minimisation of drive test, MDT, procedure to a network entity (242).

In an optional example, the network entity (242) may be operable to request the history of RRC_CONNECTED state measurements from the at least one wireless communication unit (280) using a minimisation of drive test, MDT, procedure.

In an optional example, the network entity (242) may be operable to request the history of RRC_CONNECTED state measurements from the at least one wireless communication unit (280) periodically or in response to a network entity (242) trigger event.

In an optional example, the at least one wireless communication unit (280) may be operable to unilaterally transmit the history of RRC_CONNECTED state measurements to the network entity (242) periodically or in response to a wireless communication unit (280) trigger event.

In an optional example, the history of RRC_CONNECTED state measurements and stored by the at least one wireless communication unit (280) may be performed over a predefined or configurable time-interval.

In an optional example, the configurable time-interval comprises one of: (i) a length of time that the at least one wireless communication unit (280) performs measurements where a most recent number of timeslots are stored at the at least one wireless communication unit (280) memory device (316); (ii) at least one periodicity parameter; (iii) a frequency that a history of RRC_CONNECTED state measurement information report is updated; (iv) an amount of time included in an updated history of RRC_CONNECTED state measurement information report; (v) requests of multiples of the wireless communication unit (280) history information reports for specific wireless communication units (280).

In an optional example, the history of RRC_CONNECTED state measurements performed, stored and accessed by the at least one wireless communication unit (280) may comprise a Modulation and Coding Scheme, MCS, value for downlink and uplink communications for the wireless communication unit (280).

In an optional example, the wireless communication system (200, 300) may further comprise at least one Management Data Analytics, MDA, circuit (210, 220, 230) coupled to the network entity (242) and operable to perform data analytics on the history of RRC_CONNECTED state measurements.

In an optional example, the at least one MDA circuit (210, 220, 230) may be operable to predict behaviour of the at least one wireless communication unit (280) in RRC_CONNECTED mode and provide user-centric decisions therefrom at the network entity (242).

In an optional example, the least one MDA circuit (210, 220, 230) is operable to perform data analytics on the history of RRC_CONNECTED state measurements to provide at least one of: anomaly detection, load balancing, energy saving.

In an optional example, the history of RRC_CONNECTED state measurements may comprise at least one of the following: (i) a Logging interval; (ii) a Measurement duration (iii) A flag operable to indicate the measurements to be logged; and (iv) A UE Reporting Criteria.

In an optional example, the Logging interval may be set to a configurable value or may be configurable to set a periodicity of storing MDT measurements.

In an optional example, the measurement duration may be set according to one of: record measurements at each timeslot until a new measurement configuration is received; configurably set to a number of measurements; a continuous period of time; a fixed period of time; and a fixed period of time that covers an anomaly investigation time.

In an optional example, the flag may be operable to select one of: individual measurements to be recorded by the at least one wireless communication unit (280); at least one measurement type to be recorded.

In this manner, a number of limitations with the current approaches when using MDT procedures to obtain UE information in general, and for handover purposes in particular, may be alleviated.

### Advantageous Effects of Invention

Aspects of the present disclosure provide efficient communication methods in a wireless communication system.

### BRIEF DESCRIPTION OF DRAWINGS

Further details, aspects and embodiments will be described, by way of example only, with reference to the drawings. In the drawings, similar reference numbers are used to identify like or functionally similar elements. Elements in the figures are illustrated for simplicity and clarity and have not necessarily been drawn to scale.

FIG. 1 illustrates a coordination between NWDAF, gNB and MDAS (MDA MnS) producer [4].

FIG. 2 illustrates a high-level block diagram of UE history Information and UE analytics report exchange for improved SON decisions in a 6G network model, in accordance with some example embodiments.

FIG. 3 illustrates a block diagram of an 5G/6G base station (e.g., gNB) communicating with a UE, adapted in accordance with some example embodiments.

FIG. 4 illustrates an example of a simplified message sequence chart of a Logged RRC_CONNECTED MDT Measurement Configuration Procedure, in accordance with some example embodiments.

FIG. 5 illustrates an example of a simplified message sequence chart of UE History Information Report Update Procedure based on Triggers at the gNB, in accordance with some example embodiments.

FIG. 6 illustrates an example of a simplified message sequence chart for a UE History Information Report Update Procedure based on Triggers at the UE, in accordance with some example embodiments.

FIG. 7 illustrates a block diagram illustrating a structure of a UE according to various embodiments of the present disclosure; and

FIG. 8 illustrates a block diagram illustrating a structure of a base station according to various embodiments of the present disclosure, as disclosed herein.

### MODE FOR THE INVENTION

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various embodiments. It will be further appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

In recent years, there has been a rapid development in communications technologies that are compliant with third generation partnership project (3GPP™) standards. A 4^{th} generation (4G) wireless communication standard (sometimes referred to as long term evolution (LTE™)) was designed to support mobile internet and higher speeds for activities, such as video streaming and gaming. The 3GPP™ standards then developed a fifth generation (5G) of mobile wireless communications, which provides a step change in the delivery of better and faster communications, for example powering businesses, improving communications within homes and spearheading advances such as driverless cars. These 5G networks have also brought about a wide range of new services, each with its own unique set of requirements categorized under three main categories: Ultra-Reliable Low-Latency Communication (URLLC), massive Machine-Type Communication (mMTC), and Enhanced Mobile Broadband (eMBB). However, as the industry looks toward the future, it is clear that 5G networks are just the beginning.

A sixth generation (6G) wireless communication standard is currently under development, as the planned successor to 5G, and will likely be significantly faster. Like its predecessors, 6G networks will likely be broadband cellular networks, in which the service area is divided into small geographical areas called cells. 6G networks are expected to be even more diverse than their predecessors and are likely to support applications beyond current mobile use scenarios, such as virtual and augmented reality (VR/AR), ubiquitous instant communications, pervasive intelligence and the Internet of Things (IoT). It is expected that mobile network operators will adopt flexible decentralized business models for 6G, with local spectrum licensing, spectrum sharing, infrastructure sharing, and intelligent automated management underpinned by mobile edge computing, artificial intelligence (AI), short-packet communication and blockchain technologies.

6G user equipment (UE) centric network requires a provision of network optimisation at the UE level. Artificial Intelligence (AI) aided UE data analytics predicting UE behaviour and service type has become critical in order to support a fully autonomous and optimised 6G network, including use cases, such as energy efficiency, mobility robustness optimisation, load balancing and anomaly detection using AI. A number of use cases based on UE related analytics are identified for Network Data Analytics Function (NWDAF) in 3GPP™ in [1], such as UE mobility prediction where UE location is required to be predicted at a tracking area (TA) or cell level, or abnormal behaviours related network data analytics to be performed. Furthermore, UE behaviour/service analytics use cases, such as NWDAF-assisted Radio Access Technology (RAT)/frequency selection and detection of anomaly events, have been introduced in [2].

3GPP™ proposed Management Data Analytics (MDA) functions that provide the analytics capability for the network data related to different network functions (NF) or entities in the network, e.g., data reported from gNB or specific core network functions. MDA can provide UE behaviour/service analytics by using MDT data and/or UE level analytics from NWDAF [4].

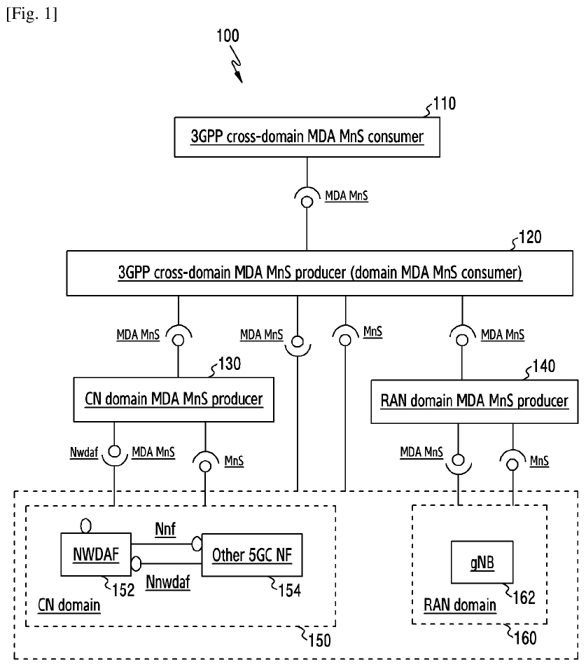

Referring to FIG. 1, coordination/communications 100 between NWDAF, gNB 162 (within a RAN domain 160) and MDAS (MDA MnS) producer is illustrated, according to [4]. A 3GPP™ cross-domain MDA MnS consumer 110 communicates with a 3GPP™ cross-domain MDA MnS producer (domain MDA MnS consumer) 120. The 3GPP™ cross-domain MDA MnS producer (domain MDA MnS consumer) 120 communicates with a Core Network domain 150 comprising a NWDAF 152 and a other 5G core network functions 154 via a CN (core network) domain MDA MnS producer 130. The 3GPP™ cross-domain MDA MnS producer (domain MDA MnS consumer) 120 communicates with a RAN domain 160 comprising a gNB 162 via a RAN domain MDA MnS producer 140.

Data-driven models that predict user behaviour and mobility patterns based on data collected from both end-users and the network itself have become the foundation for many solutions [2]. Current 3GPP™ supports a collection of UE specific radio measurements using minimisation of drive test (MDT) [3]. There are two modes of MDT measurements: (i) Logged MDT; (ii) Immediate MDT. In logged MDT, the UE is operable to log certain measurements in radio resource control (RRC)_INACTIVE state and RRC_IDLE state and reports back these measurements logged at the UE either periodically or in an event-based manner [3]. Immediate MDT measurements provide key metrics at UE level; however, these measurements are not logged/recorded at the UE as the current procedure forces these measurements to be reported as they are measured. An immediate MDT procedure is used to report RRC_CONNECTED state measurements, as listed in Table 1 below. The user equipment (UE) sends measurement reports to the network at a pre-determined reporting interval or when certain events occur. The reports include information about radio conditions, such as signal strength, signal quality, and interference levels. In Immediate MDT, measurements are performed by the UE or the gNB.

TABLE 1
Immediate MDT measuents:

M1: DL signal quantities measurement results (RSRP, RSRQ, SINR) for the serving cell
and for intra-frequency/Inter-frequency/inter-RAT neighbour cells, including cell/
beam level measurement
M2: Power Headroom measurement by UE
M3: Not supported in this release
M4: PDCP SDU Data Volume measurement separately for DL and UL, per DRB
(data radio bearer) per UE
M5: Average UE throughput measurement separately for DL and UL, per DRB per
UE and per UE for the DL, per DRB per UE and per UE for the UL
M6: Packet Delay measurement separately for DL and UL, per DRB per UE
M7: Packet loss rate measurement separately for DL and UL, per DRB per UE
M8: RSSI measurement by UE (for WLAN/Bluetooth measurement)
M9: RTT Measurement by UE (for WLAN measurement)

Table 1 describes an Immediate MDT Measurements [3].

In contrast, Logged MDT measurements are taken over a period of time and stored in a buffer on the UE. The buffer can hold a certain amount of data, which is determined by the MDT buffer size limit. Once the buffer is full, the measurements are uploaded to the network, typically upon gNB request after entering RRC_CONNECTED state. The reported latency is longer than Immediate MDT, since the measurements are not reported immediately but rather stored in the buffer and uploaded later.

Traditionally, handover management has been performed using predefined rules that determine when and how a handover should occur. However, these rules may not always result in the best handover decision, especially under dynamic network conditions or when a mobile device is moving at high speeds. As a result, there has been a growing interest in developing data-driven handover solutions that use machine learning techniques to predict and optimize handover decisions. The inventors have recognised and appreciated a number of limitations with the current approaches when using MDT procedures to obtain UE information in general, and for handover purposes in particular.

WO 2021/253399 A1 proposes a handover procedure that utilizes UE cell history information for the UE to avoid unnecessary handovers and potential handover failures. The UE cell history information in WO 2021/253399 A1 is explicitly limited to cell ID and time spent on each cell.

In contrast to the explicit teaching of WO 2021/253399 A1, examples herein described propose a wider measurement set including an UE history information report. In addition, examples herein described provide new procedures on how to configure UEs to log measurements as well as describing new procedures to update the proposed additional information to the network. Furthermore, examples herein described propose a mechanism to store these measurements in a memory device at the UE for, say, a most recent time period. Additionally, it is envisaged that the examples herein described are not limited to handover procedures only but also encompass a wide range of use cases listed, which can benefit from UE analytics generated from UE history information.

In particular, examples herein described propose a third, and new type of MDT measurement, referred to herein as a ‘logged RRC_CONNECTED MDT’ measurement, for UEs in RRC_CONNECTED state and UEs to log measurements over a certain period of time, building a UE history information report covering, say, a predefined or configurable time-interval. In particular, the new type of MDT measurement provides an enhanced version of the known immediate MDT. In some examples, it is proposed that the UE stores RRC_CONNECTED MDT data for the most recent ‘x’ timeslots in a memory device, and makes this information available to the network whenever it is required by the network. In some examples, detailed in Logged RRC_CONNECTED MDT Configuration” procedure, there are 2 parameters controlling how long and how frequently measurements are collected: (i) Logging Interval; (ii) Measurement Duration. In this manner, it is envisaged that the UE history information may be retained and stored in a memory device at the UE, thereby eliminating a potential problem of UE data being partially available at different gNBs due to UE mobility (e.g., handovers).

In some examples herein described it is envisaged that the UE stores the MDT data in a memory device and subsequently the UE history information report may be updated to the gNB from the memory device, for example based on certain triggers that may be configured either at the UE or gNB. In this manner, the UE history information may be made available at the network when it is required, as opposed to current immediate MDT procedure where measured data is collected and sent to the network immediately after collection [3].

Additionally, in some examples, it is proposed to add an additional measurement into the existing measurements proposed for immediate MDT procedure given in Table 1 (see for example Table 2). In one example, a Modulation and Coding Scheme (MCS) value may be used in uplink (UL) and downlink (DL) per UE may be added. In this manner, MCS information provides a strong indication of the radio environment and, hence, it can be used to estimate the number of physical resource block (PRB) resources required for a given throughput requirement. Higher order MCS is used when radio conditions are good, i.e., high SINR, and lower order MCS is used when radio conditions are poor, i.e., low SINR. With the historical view of MCS and reference signal received power (RSRP)/signal-to-interference-plus-noise ratio (SINR) (i.e., M1 in Table 1) and UE average throughput measurement (i.e., M5 in Table 1), a predicted resource usage for the UE at serving and neighbour gNBs may be driven. This prediction can assist an improved handover decision considering the predicted resource allocation at the target cell. In the case of highly utilized target cells, traditional handover can be avoided if there are no sufficient resources available at the target cell. Similarly, this prediction can improve load balancing use case to find suitable target cell for a UE connected to a source cell in congestion. A target cell is selected if it is lightly loaded and predicted target cell load with the addition of this UE load doesn't exceed a threshold (e.g., load balancing). Moreover, this prediction can also help energy efficiency use case to find suitable target cells for UEs connected to lightly loaded cells where target cell predicted load with the addition of this UE doesn't exceed a threshold. UEs at the lightly loaded cells can be handed over without QoS reduction, leading to lightly loaded cells being switched off earlier for additional energy saving. As will be appreciated by a skilled artisan, this proposed additional measurement is not limited to use in logged MDT or immediate MDT or indeed the proposed and described ‘Logged RRC_CONNECTED MDT’ measurement.

Examples herein described differ from the current 3GPP™ use of UE specific radio measurement collection using minimisation of drive test (MDT), i.e., logged MDT measurements and immediate MDT measurements, based on at least the following criteria. In a first aspect, a new type of MDT named logged RRC_CONNECTED MDT″ is proposed, enhancing the current immediate MDT procedure to enable measurement logging at the UE in RRC_CONNECTED state, creating a UE history information report. Thus, a number of UEs maintain a history of RRC_CONNECTED measurements and report these measurements back to the network whenever reporting criteria are triggered, e.g., when the report is required for analytics purposes. It is envisaged that the triggers to report UE history information report can be initiated at the UE side or at the gNB. A list of envisaged sample trigger condition examples at the gNB include, for example: (i) Source Cell Load<Thresh(ES); (ii) Source Cell Load>Thresh (LB); (iii) Periodic Update. envisaged trigger. A list of envisaged sample trigger condition examples at the UE include, for example: (i) Serving cell RSRP<Threshold (event A2); (ii) Nei cell RSRP>Serving cell RSRP (Event A3); (iii) Nei cell RSRP>Threshold (Event A4). It is envisaged that other trigger condition examples may be employed for other use cases, as appropriate. Such an approach is in direct contradiction to the current 3GPP™ approach in immediate MDT whereby the UE is operable to measure RRC_CONNECTED measurements for a certain time period only and report back most measurements at the end of the measurement collection period. In this first aspect, in one example, it is proposed to build a RRC_CONNECTED UE measurement dataset in MDAS, where UE analytics reports can be generated for multiple use cases.

Examples herein described differ from the current 3GPP™ use of UE specific radio measurement collection using MDT with additional signalling to make use of collected data for UE analytics at the MDAS producer and provide a UE analytics report to the gNB for better management decisions on multiple use cases. In some examples, the additional signalling may be used for at least one of: configuring the new logged RRC_CONNECTED MDT; reporting of UE History Information Report based on triggers or periodically; passing on UE history report to MDA and MDA to produce UE analytics report to use in self-organizing network, SON, functions at gNB, as described later. Examples herein described further differ from the current 3GPP™ use of UE specific radio measurement collection using MDT with a use of an additional measurement beyond 3GPP immediate MDT, i.e., MCS to be measured. In this manner, a historical view of MCS may be built at the UE at each cell, which may provide a strong indication of the radio environment and help to predict PRB usage for the UE at the target cell before handover decision is made. In one example, the MCS measurement may be included in the proposed logged RRC_CONNECTED MDT″ which is illustrated below in Table 2. It is known that MCS is used in RRC_Connected mode only, and therefore in examples herein described it will be measured as part of logged RRC_CONNCTED MDT″ MCS is not available in idle_mode.

In 5G, MCS is a numeric value that maps to a specific modulation order (e.g., 5G supports QPSK, 16 QAM, 64 QAM and 256 QAM modulation) and a target code rate. A higher MCS is used when the radio conditions are better (i.e., high SINR), leading to better spectral efficiency i.e., for a given throughput requirement, less radio resources are required. On the other hand, lower MCS is used when radio conditions are worse (i.e., low SINR) and this leads to lower spectral efficiency and hence higher number of PRB usage is required for any given throughout requirement. A historical view of MCS values used at each cell for a UE, together with RSRP/SINR (i.e., M1 in Table 1) and UE average throughput measurement (i.e., M5 in Table 1), a predicted resource usage for the UE at serving and neighbour gNBs may be driven.

In some examples, these measurements will be logged periodically for a configurable fixed duration. In some examples, these measurements will also be recorded with a time stamp and a location of the UE, which may be added to each measurement set. Once measurements are collected for the fixed duration, new measurements may be updated in the report, with the oldest measurements being discarded, thereby keeping the most up-to-date measurements covering the most recent configurable fixed duration.

TABLE 2
Logged RRC_CONNECTED MDT Measurements:

M1: DL signal quantities measurement results (RSRP, RSRQ, SINR) for the serving
cell and for intra-frequency/Inter-frequency/inter-RAT neighbour cells, including
cell/beam level measurement
M2: Power Headroom measurement by UE
M3: Not supported in this release
M4: PDCP SDU Data Volume measurement separately for DL and UL, per DRB
per UE
M5: Average UE throughput measurement separately for DL and UL, per DRB per
UE and per UE for the DL, per DRB per UE and per UE for the UL
M6: Packet Delay measurement separately for DL and UL, per DRB per UE
M7: Packet loss rate measurement separately for DL and UL, per DRB per UE
M8: RSSI measurement by UE (for WLAN/Bluetooth measurement)
M9: RTT Measurement by UE (for WLAN measurement)
M10: Modulation and coding Scheme (MCS) for DL and UL per UE

Table 2 describes a Logged RRC_CONNECTED MDT Measurements, notably with a new M10

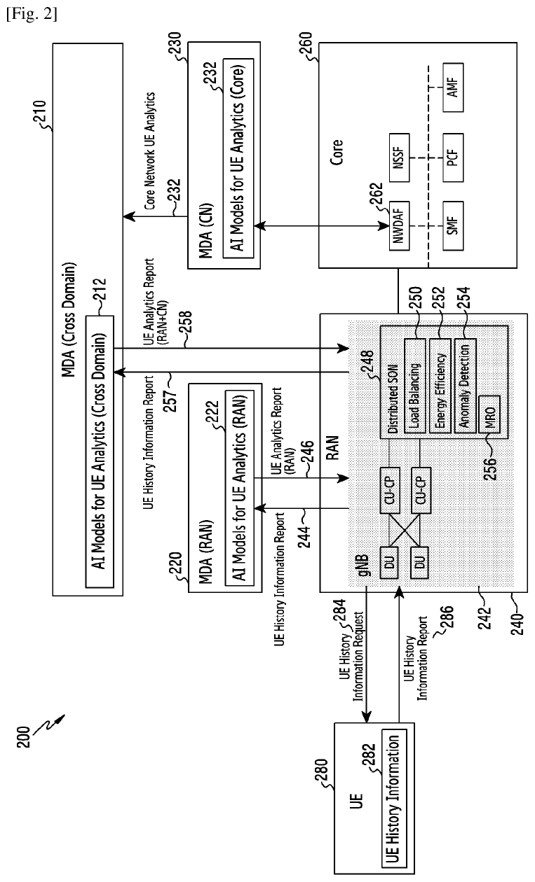

Referring now to FIG. 2, a high-level block diagram 200 of UE history Information and UE analytics report exchange for improved SON decisions in a 6G network model is illustrated, in accordance with some example embodiments. In FIG. 2, a 3GPP™ Management Data Analytics (MDA) cross domain function 210 comprises AI models for UE data analytics (cross domain) circuit 212 and provides the data analytics capability for the network data related to different network functions (NF) or entities in the network, e.g., data reported from gNB 242 in RAN 240 or specific core network functions 260 in 258, as well as receiving an UE history information report 257 from a gNB 242 in a RAN 240.

A MDA RAN 220 comprises AI models for UE data analytics (RAN domain) circuit 222 and provides a UE analytics report (RAN) 246 to the RAN 240 after receiving an UE history information report 244. A MDA (CN) 230 comprises AI models for UE data analytics (CN domain) circuit 232 and can provide UE behaviour/service analytics by using MDT data and/or UE level analytics from NWDAF 262.

With the proposed examples described herein, once triggering criteria is met, UE history information report 286 is updated at the gNB 242 and passed onto the MDAS 210, 220, 230 for analytics purposes. The MDAS 210, 220, 230 feed the most up-to-date UE history information from the UE 280 as an inference input to, say, respective trained artificial intelligence (AI) models (through UE data analytics circuits 222, 232) and a UE analytics report is generated. The UE Analytics report is sent 246 to gNB 242 for it to be used, say, in a distributed self-organizing network (SON) entity 248 residing, say, at the gNB 242 in order to make improved UE-centric decisions on SON functions, such as energy saving/efficiency 252, load balancing 250, MRO 256, anomaly detection 254, etc. In some examples, the MDAS may be a RAN domain MDAS 220, operable to produce an UE analytics report based on collected RAN data only. In some examples, the MDAS may be a cross-domain MDAS 210 where UE data from core network can also be available at MDAS, producing improved cross-domain UE analytics with the help of new UE history information report.

In some examples, it is envisaged that one of the triggers from the gNB 242 may be a periodic update, where the network is able to configure periodicity parameters of how often and how long ago in history the UE history information report is updated at MDAS 220. In some examples, the configurability of the triggers and updates may be arranged to cover a range of time and frequency. For example, depending on a use case, it is envisaged that AI models (through UE data analytics circuits 212, 222, 232) may be trained with periodically updated UE data, and the requirement of time frequency can change based on use case. Periodic updates can be used at MDAS 220, 230 for UE analytics AI model training. In some examples, it is envisaged that the network may be able to configure requests of UE history information report from certain UEs, for example by specifying UE IDs or by identifying UEs by certain attributes e.g., UEs in a certain area, etc.

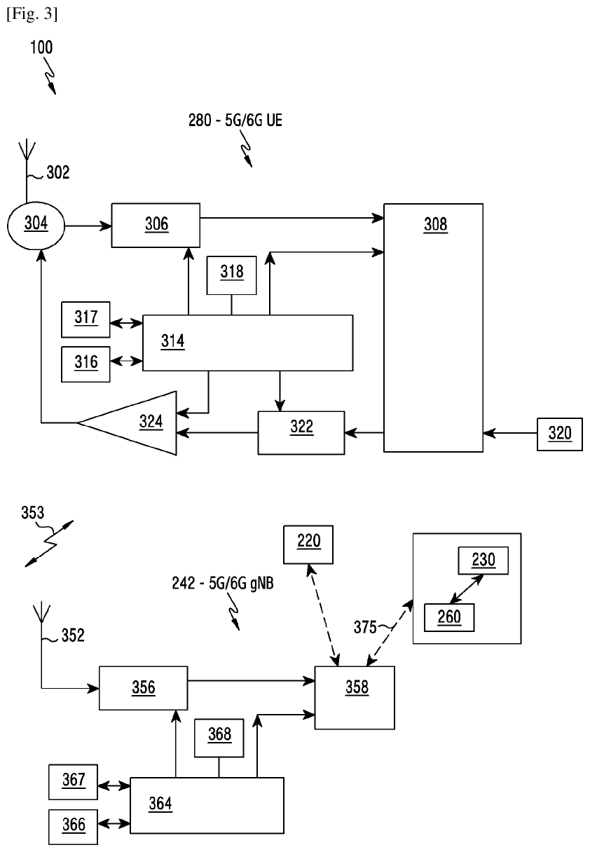

Referring now to FIG. 3, a block diagram of a wireless communication unit, e.g., an UE 280, communicating with a network entity such as a 5G/6G gNB 242, is illustrated, adapted in accordance with some example embodiments.

The UE 280 contains an antenna 302, for receiving transmissions, coupled to an antenna switch and/or duplexer 304 that provides isolation between receive and transmit chains within the UE 280. One or more receiver chains, as known in the art, include receiver front-end circuitry 306 (effectively providing reception, filtering and intermediate or base-band frequency conversion). The receiver front-end circuitry 306 is coupled to a signal processor 308 (generally realized by a digital signal processor (DSP)). A skilled artisan will appreciate that the level of integration of receiver circuits or components may be, in some instances, implementation-dependent.

A controller 314 maintains overall operational control of the UE 280. The controller 314 is also coupled to the receiver front-end circuitry 306 and the signal processor 308. In some examples, the controller 314 is also coupled to a frequency generation circuit 317 and a memory device 316 that selectively stores operating regimes, such as decoding/encoding functions, synchronization patterns, code sequences, and the like. In accordance with examples described herein, the UE 280 is operable to store Logged_RRC_CONNECTED MDT data for, say, a most recent ‘x’ timeslots in the memory device 316. In some examples, the memory device 316 also stores MCS data of the UE. Furthermore, the signal processor 308 (together with a transmitter chain) makes this information available to the network whenever it is required by the network. A timer 318 is operably coupled to the controller 314 to control the timing of operations (e.g., transmission or reception of time-dependent signals) within the UE 280.

As regards the transmit chain, this essentially includes an input circuit 320, coupled in series through transmitter/modulation circuitry 322 and a power amplifier 324 to the antenna 302, antenna array, or plurality of antennas. The transmitter/modulation circuitry 322 and the power amplifier 324 are operationally responsive to the controller 314. The signal processor 308 in the transmit chain may be implemented as distinct from the signal processor in the receive chain. Alternatively, a single processor may be used to implement a processing of both transmit and receive signals, as shown in FIG. 3. Clearly, the various components within the UE 280 can be realized in discrete or integrated component form, with an ultimate structure therefore being an application-specific or design selection.

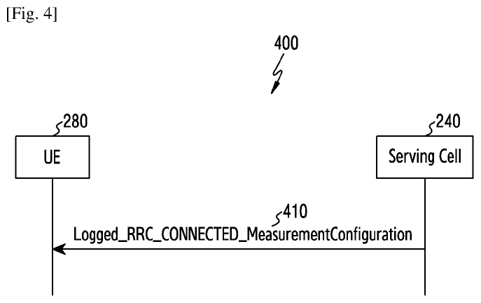

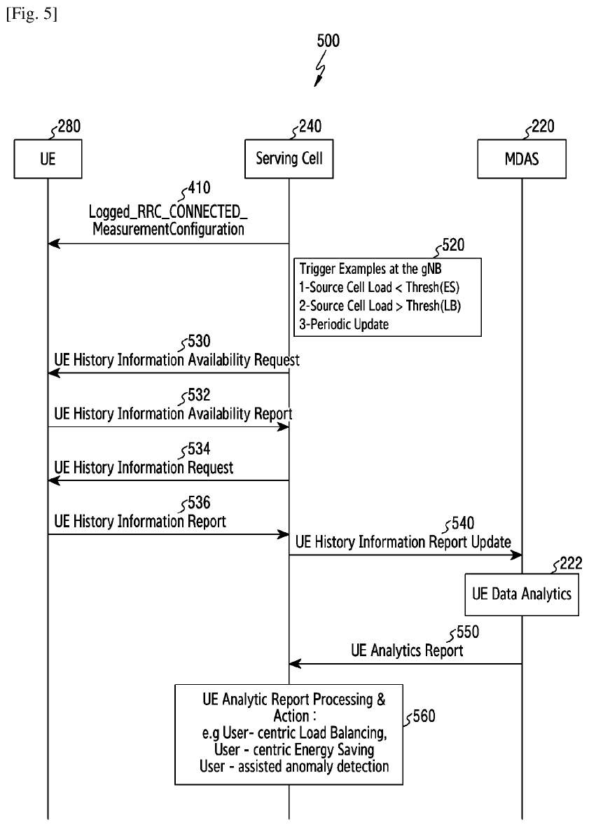

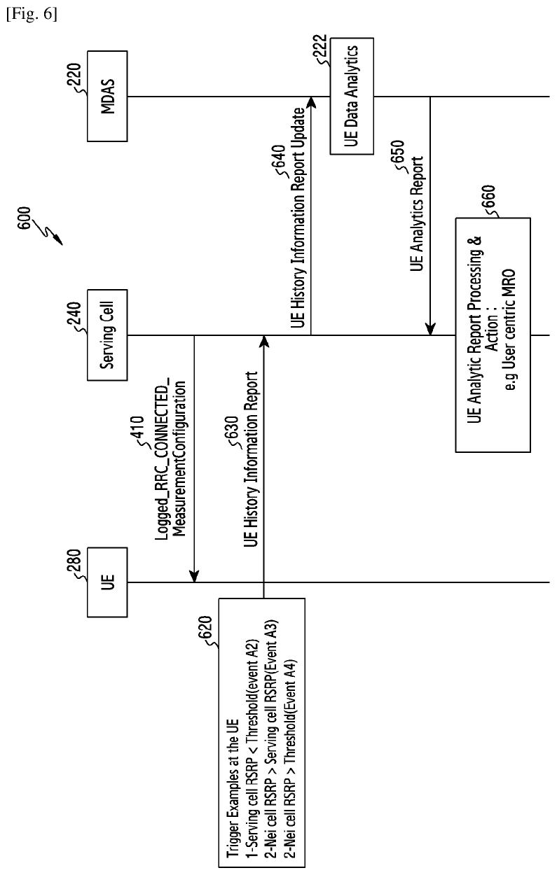

The processor 308 and transceiver (e.g., transmitter/modulation circuitry 322 and receiver front-end circuitry 306) of the UE 280 are operable to receive a Logged RRC_CONNECTED MDT Measurement Configuration request from, say, a 5G/6G network entity (e.g., gNB 242), perform a series of UE-based measurements according to the request/instructions and send a UE History Information Report to the 5G/6G network entity (e.g., gNB 242). Examples of some communications are illustrated in accordance with the approach described in one of FIG. 4, FIG. 5, and FIG. 6.

FIG. 3 also shows a high-level block diagram of a 5G/6G network entity (e.g., gNB 242). In this example, the gNB 242 is illustrated as a predominantly wireless device with a wireless connection 353 to the UE 280. In this example, the gNB 242 contains an antenna 352, for receiving RAN data transmissions from the UE 280. The antenna 352 is coupled to one or more receiver chains, as known in the art, include receiver front-end circuitry 356 (effectively providing reception, filtering and intermediate or base-band frequency conversion). The receiver front-end circuitry 356 is coupled to a signal processor 358 (generally realized by a digital signal processor (DSP)). A skilled artisan will appreciate that the level of integration of receiver circuits or components may be, in some instances, implementation-dependent.

The controller 364 maintains overall operational control of the gNB 242. The controller 364 is also coupled to the receiver front-end circuitry 356 and the signal processor 358. In some examples, the controller 364 is also coupled to a frequency generation circuit 367 and a memory device 366 that selectively stores operating regimes, such as decoding/encoding functions, synchronization patterns, code sequences, and the like. A timer 368 is operably coupled to the controller 364 to control the timing of operations (e.g., reception of time-dependent signals) within the gNB 242.

In accordance with examples herein described, once a MDA desires UE history information, the gNB 242 in the RAN 240 receives a request and generates a UE history information request 284 that is sent to at least one UE 280. In one example, the UE history information request 284 is in a form of a Logged RRC_CONNECTED MDT Measurement Configuration request from the gNB 242. Following the requested UE 280 performing a series of UE-based measurements according to the request/instructions, the gNB 242 receives a UE History Information Report, processes the UE History Information Report and routes its processed findings (or the initial Report(s) from the UE 280) to the Core network or an MDA (RAN) 220 or a MDA (Cross-domain) 210. It is envisaged that the signal processor 358 may be realized in discrete or integrated component form, with an ultimate structure therefore being an application-specific or design selection.

In this example, the gNB 242 in the RAN 240 is also coupled 375 to a Core Network 260 and a MDA (CN) 230. In this manner, the MDA (CN) 230 may desire UE history information, and instruct the gNB 242 in the RAN 240 to generate a UE history information request 284 that is sent to at least one UE 280.

### Logged RRC_CONNECTED MDT Configuration:

Referring now to FIG. 4, an example of a simplified message sequence chart 400 of a Logged RRC_CONNECTED MDT Measurement Configuration Procedure is illustrated, in accordance with some example embodiments. The simplified message sequence chart 400 includes a UE 280 communicating with a serving cell (in RAN 240), e.g., a gNB 242.

In this described example, the MDT requesting UE information is a Logged_RRC_Connected_MeasurementConfiguration message 410, requested by the serving cell (in RAN 240) of the UE 280. In some examples, the Logged_RRC_Connected_MeasurementConfiguration message 410 is configured by using an enhanced version of the existing 3GPP™ logged MDT measurement configuration.

Examples described herein are proposed for RRC_CONNECTED measurements only, with example contents of the RRC_CONNECTED measurements proposed in Table 2; however, it is envisaged that measurements may be extended to other RRC_CONNECTED mode measurements.

In some examples, it is envisaged that the radio access network (RAN) 240 may initiate the procedure with, say, a Logged_RRC_CONNECTED_MeasurementConfiguration” message 284, sent to the UE 280. In some examples, the message 284 may contain the configuration parameters for Logged RRC_CONNECTED MDT. In some examples, the Logged_RRC-CONNECTED_MeasurementConfiguration message 284 may also include the following configuration parameters:
(i) Logging interval: In some examples, it is envisaged that the Logging interval may be set to any value, e.g., fully configurable where a very short interval may be set for finer granularity measurements, which can produce finer UE analytics, but with the cost of finer measurement collection at the UE 280. In some examples, a longer time interval may be selected depending upon which use case UE analytics report is required for. In this regard, a longer time interval will likely reduce the measurement overhead at the UE 280. In some examples the logging interval may set the periodicity of storing the MDT measurements.
(ii) Measurement duration: In some examples, it is envisaged that Measurements will be logged at each timeslot set by logging interval with no end time until a new logged_RRC_CONNECTED_MeasurementConfiguration is received to stop measurements. In this regard the UE will store the last certain number of measurements set by the measurement duration” parameter. In some examples, it is envisaged that the Measurement duration may be set to either a continuous or a fixed period of time. For example, if an anomaly was investigated, the measurement duration may be set to a fixed duration to cover the investigation time only to reduce measurement overhead. Alternatively, for example, a continuous measurement may be selected where UE 280 can measure continuously and always record the most up-to-date history 282 so that it can be made available to the RAN 240 whenever it is required (e.g., based on triggers or periodically).
(iii) A flag to indicate which measurements to be logged: In some examples, it is envisaged that this flag may provide the full flexibility on which measurements from Table 2 are required. Depending on the use case, some or all measurements may be selected. In one example, a flag for each measurement type is proposed to indicate which measurements listed in Table 2 are to be logged. Stored measurements from a Logged RRC_CONNECTED MDT is identified as a UE History Information Report” 286.
(iv) UE Reporting Criteria: In some examples, it is envisaged that example UE reporting criteria may include one or more of the list below (noting that it is envisaged that skilled artisans will readily understand that other criteria may also be used).
   Various 3GPP event criteria for reporting measurement reports can be replicated to report UE history information report;
   Serving cell RSRP<Threshold (3GPP™ event A2 can be utilised);
   Nei cell RSRP>Serving cell RSRP (3GPP™ Event A3 can be utilised); and
   Nei cell RSRP>Threshold (3GPP™ Event A4 can be utilised).

In some examples, it is envisaged that updates of the UE history information report 286, sent to the RAN 240, may be periodical and/or event triggered. Triggering events can be configured at UE 280 and/or gNB 242. UE reporting criterias are configured in Logged_RRC-CONNECTED_MeasurementConfiguration message. For example, 3GPP defined triggering events such as event A2, A3, A4 etc., can be configured or additional events can be defined where UEs will send stored UE history information reports 286 to the gNB 242 when event triggering criterias are met.

### UE History Information Report Update Procedure:

In some examples, the UE history information report 286 stored at the UE 280 may be updated at the gNB 242 when a triggering event condition is met cither at the UE 280 or gNB 242 using an UE history information report update procedure. In some examples, it is proposed that the UE history information report update procedure may be an extension of the UE information procedure used for 3GPP™ Logged_RRC_ONNECTED MDT measurement updates from UE to the network as detailed in Section 5.7.10 in [5].

Referring now to FIG. 5, an example of a simplified message sequence chart 500 of UE History Information Report Update Procedure based on triggers at the gNB is illustrated, in accordance with some example embodiments. The simplified message sequence chart 500 includes communications between a UE 280, a serving cell (e.g., in a form of a gNB 242) and MDAS 370. In this described example, the simplified message sequence chart 500 starts with the gNB 242 requesting UE information via a Logged_RRC_Connected_MeasurementConfiguration message 410, of the UE 280. In some examples, the Logged_RRC_Connected_MeasurementConfiguration message 410 is configured by using an enhanced version of the existing 3GPP™ logged MDT measurement configuration.

When an event configured at the gNB 242 is triggered at 520 (for example gNB load>threshold for load balancing), the gNB 242 initiates the procedure by sending a UE History Information Availability Request” at 530 and the UE 280 responds with UE History Information Availability Report” at 532. In some examples, the Availability Report at 532 contains those measurements in Table 2 that are available at the UE 280. In this example, based on the Availability Report at 532, the gNB 242 sends a UE History Information Request” at 534 that indicates which measurements from the Availability Report are required. The UE 280 responds with a UE History Information Response “message at 536, where the message contains a UE History Information Report”

In some examples, it is envisaged that one of the triggers at the gNB 242 may be a periodic update where a UE history information report update procedure is triggered periodically in order to maintain a full UE history at MDAS 220, for example to provide detailed analytics for one or more of the use cases described below. In this example, it is envisaged that periodic update configuration may include how often and how far in history the UE history information should be passed onto MDAS. In this example, it is envisaged that periodic update configuration may include which UEs to collect the data from by specifying UE IDs or by identifying UEs in a given area.

At 540, the UE history information report is then sent to MDAS 220 producer to update the central UE data repository at the MDAS producer. In some examples, it is proposed that a data analytics circuit 222 located at the MDAS 220 producer utilizes the UE level data and provides UE analytics reports, for example to other RAN or CN entities. In this example, the UE analytics report at 550 is generated based on the input UE data received and sent back to gNB 242 to use for UE-assisted use cases, for example as listed below. An example of UE data analytics circuit 222 may be a trained AI model that is used to predict UE behaviour in future, and in such an example, the UE history information report may be used as an input to an inference function of the trained model at MDAS 220.

Referring now to FIG. 6, an example of a simplified message sequence chart 600 for a UE History Information Report Update Procedure based on triggers at the UE is illustrated, in accordance with some example embodiments. The simplified message sequence chart 600 includes communications between a UE 280, a serving cell (e.g., in a form of a gNB 242) and a MDAS 220. In this described example, the simplified message sequence chart 600 starts with the gNB 242 requesting UE information via a Logged_RRC_Connected_MeasurementConfiguration message 410, of the UE 280. In some examples, the Logged_RRC_Connected_MeasurementConfiguration message 410 is configured by using an enhanced version of the existing 3GPP™ logged MDT measurement configuration.

With this Logged_RRC_Connected_MeasurementConfiguration message 410, proposed Logged_RRC_CONNECTED MDT measurements are configured, so that the UE starts collecting and storing the measurement, or configuration parameters of an existing MDT collection is/are revised. After some time, when one of the events configured at the UE is triggered, then UE History Information Report” is sent from UE to gNB.

In this case, an event configured at the UE 280 is triggered at 620. Here, the UE 280 may be operable to send a UE History Information Report” message 630 to the gNB 242 containing the stored UE History information. Notably this message 630 is sent without a need for the UE History Information Request” 534 from the gNB 242, as illustrated in the message sequence chart 500 of FIG. 5. In this scenario, the rest of the procedure may follow the same procedure detailed for the earlier case when it is triggered from gNB 242, as illustrated in FIG. 5.

Thus, at 640, the UE history information report is then sent to MDAS 220 producer to update the central UE data repository at the MDAS producer. In some examples, it is proposed that a data analytics circuit 222 located at the MDAS 220 producer utilizes the UE level data and provides UE analytics reports, for example to other RAN or CN entities. In this example, the UE analytics report at 650 is generated based on the input UE data received and sent back to gNB 242 to use for UE-assisted use cases, for example as listed below. An example of UE data analytics circuit 222 may be a trained AI model that is used to predict UE behaviour in future, and in such an example, the UE history information report may be used as an input to an inference function of the trained model at MDAS 220.

### Use Cases:

It is envisaged that there are many applications/use cases for the concepts herein described. Referring back to FIG. 2, it is envisaged that a distributed SON 248 may be operable to take advantage of the information provided in a received UE Analytics Report, based on UE history, (e.g., Load Balancing, energy efficiency, MRO, etc.). A first example is described of a sample UE analytic report generated from collected UE data based on the proposed logged RRC_CONNECTED MDT. A second example is described of use cases where a UE analytics report can be used for improved user-centric decisions.

### UE Analytics Report:

In some examples, the UE analytics report 550, 650 is operable to comprise predicted UE attributes in order to make more accurate UE-centric decisions on various use cases, such as user-centric MRO, energy-saving, load-balancing and anomaly detection. A sample UE analytics report showing predicted UE attributes for current time+x timeslot is provided in Table 3 below. It is envisaged that a complete report may comprise predictions at each timeslot in future, e.g., for a configurable time period.

TABLE 3

| | | | 2nd | 3rd | xth | | | |
|---|---|---|---|---|---|---|---|---|
| Attribute | Cell | Best | Best | Best | Best | Anomaly | | |
| Name | Independent | cell | Cell | Cell | cell | detected | Description | Use Case |
| Projected | (x, y) | n/a | n/a | n/a | n/a | False | AI model is trained using | User-centric |
| UE location | | | | | | | historical UE location in | ES/LB |
| | | | | | | | UE history information | |
| | | | | | | | reports to predict UE location | |
| | | | | | | | in the next x timeslots. | |
| Projected | 3 | n/a | n/a | n/a | n/a | False | Historical UE location can | User-centric |
| UE speed | | | | | | | be used to drive UE speed | MRO |
| | | | | | | | and AI model can be trained | |
| | | | | | | | on historical UE speed to | |
| | | | | | | | predict UE speed in future. | |
| Projected | n/a | Cell | Cell | Cell | Cell | False | AI model is trained on signal | User-centric |
| UE Serving | | ID1 | ID2 | ID3 | IDX | | quality measurements | MRO |
| Cell | | | | | | | of serving and neighbour | |
| | | | | | | | cells (RSRP, RSRQ) and | |
| | | | | | | | UE location information to | |
| | | | | | | | predict the best, 2nd best, | |
| | | | | | | | 3rd best cells in future. | |
| Projected | n/a | 300 | 300 | — | — | False | AI model is trained using | User-centric |
| UE throughput | | | | | | | historical UE throughput | ES/LB |
| | | | | | | | to predict UE throughput | |
| | | | | | | | in future at predicted best | |
| | | | | | | | cell, 2nd best cell, 3rd | |
| | | | | | | | best cell | |
| Projected | n/a | 1 | 2 | — | — | False | AI model is trained using | User-centric |
| UE packet | | | | | | | historical UE packet delay | ES/LB |
| delay | | | | | | | to predict UE packet delay | |
| | | | | | | | in future at predicted best | |
| | | | | | | | cell, 2nd best cell, 3rd | |
| | | | | | | | best cell | |
| Projected | n/a | 2 | 3 | — | — | False | AI model is trained using | User-centric |
| UE PRB | | | | | | | historical MCS to predict | ES/LB |
| usage | | | | | | | MCS in future and derive | |
| | | | | | | | an estimated average PRB | |
| | | | | | | | usage based on predicted | |
| | | | | | | | UE throughput at the | |
| | | | | | | | predicted best cell, 2nd | |
| | | | | | | | best cell, 3rd best cell. | |

Table 3 describes a sample UE Analytics Report Showing Predicted UE Attributes at Current_Time+x

### UE-Centric Anomaly Detection Use Case:

In some examples, the UE data analytics circuit 222 at MDAS 220 producer may be operable to provide anomaly detection based on, say, one or more of: historical RSRP, signal-to-noise interference ratio (RSRQ), MCS, data throughput and packet delay measurements. If there is an anomaly on the received measurements, for example as compared to an historical trend, an anomaly flag in UE analytics report may be updated and notified to gNB 242. This information may be used to identify any fault in any network function causing the anomaly.

### UE-Centric Mobility Robustness Optimisation (MRO):

In some examples, the UE analytics report may be operable to provide projected UE location, speed and a best serving cell for a certain duration in future. For high speed UEs, it is desired to keep the UE at a macro cell layer and avoid handover to small cells where coverage is smaller and the time spent in the small cell is very short, i.e., another handover to return to the initial macro cell may be triggered shortly after the first handover. Thus, in some examples, the UE analytics report may be utilized for a better handover decision and avoid macro to small cell handovers if the projected time spent at the target small cell is very short for high speed UEs.

In some examples, a second MRO use case may be to utilize UE speed from an UE analytics report and classify MRO related measurements (e.g., as being too early/too late/HO to wrong cell as defined in [6]) based on UE speed. In some examples, a different cell individual offset may be applied for each neighbour pair based on UE speed.

### UE-Centric Energy Efficiency:

In some examples, when a serving gNB load (PRB utilization) is lower than a threshold, it may be desirable to understand whether (or not) the predicted UE QoS requirements may be met by any neighbour cells, so that the serving cell load can be re-distributed to neighbour cells. Here, in this manner, the UE analytics report may be utilized to select best neighbour cells for handover and switch off the serving gNB for energy efficiency purposes. In some examples, the UE analytics report may help to provide an insight on UE's predicted behaviour and to find candidate cells for handover that can meet UE QoS requirements.

### UE-Centric Load Balancing:

In some examples, when a serving gNB load is higher than a threshold, some of the load needs to be distributed to neighbour cells in order to off-load the source cell and relieve congestion. In some examples, the UE analytics reports may be used to assist understanding the predicted UE behaviour and finding the best neighbour cell for handover that can meet UE QoS requirements.

Furthermore, it is envisaged that the proposed methods may also be used by a MDAS feeds the most up-to-date UE history information from the UE as an inference input to a trained AI model. In this manner, the MDAS may be operable to provide enough data for a training phase, that helps create more accurate and reliable handover mobility management predictions, especially for high-speed mobility scenarios, where UEs move quickly between network entities. By having access to sufficient data from neighbouring network entities, a ML model can better understand the patterns of UE movement and can provide more accurate predictions for, say when a handover is necessary.

Examples herein described provide a system, various modified devices, new interfaces, new signalling and methods for wider measurement set for UE history information report and provide new procedures on how to configure UEs to log measurements as well as describing new procedures to update new, additional information to the network. In particular, examples herein described provide an enhanced version of the known immediate MDT. Furthermore, examples herein described have described a mechanism to store these measurements at the UE for, say, a most recent time period. In addition, and alternatively, examples herein described propose an additional measurement be carried out. In this example, the overall measurement list transitions to the one provided in Table 2. Additionally, it is envisaged that the examples herein described are not limited to handover procedures only but also encompass a wide range of use cases listed, which can benefit from UE analytics generated from UE history information.

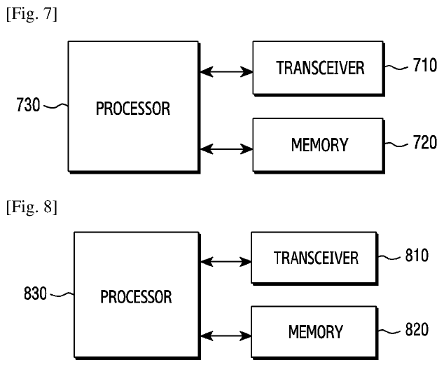

FIG. 7 illustrates a block diagram illustrating a structure of a UE according to various embodiments of the present disclosure. FIG. 7 corresponds to the example of the UE of FIG. 3

As shown in FIG. 7, the UE according to an embodiment may include a transceiver 710, a memory 720, and a processor (e.g. controller) 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor.

The transceiver 710 collectively refers to a UE receiver and a UE transmitter, and may transmit/receive a signal to/from a base station. The signal transmitted or received to or from the base station may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station, and the processor 730 may determine a result of receiving the control signal and the data signal transmitted by the base station.

FIG. 8 illustrates a block diagram illustrating a structure of a base station according to various embodiments of the present disclosure. FIG. 8 corresponds to the example of the base station of FIG. 3.

As shown in FIG. 8, the base station according to an embodiment may include a transceiver 810, a memory 820, and a processor (e.g. controller) 830. The transceiver 810, the memory 820, and the processor 830 of the base station may operate according to a communication method of the base station described above. However, the components of the network entity are not limited thereto. For example, the base station may include more or fewer components than those described above. In addition, the processor 830, the transceiver 810, and the memory 820 may be implemented as a single chip. Also, the processor 830 may include at least one processor.

The transceiver 810 collectively refers to a base station receiver and a base station transmitter, and may transmit/receive a signal to/from a terminal. The signal transmitted or received to or from the terminal may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the network entity operates as described above. For example, the transceiver 810 may receive a data signal including a control signal transmitted by the terminal, and the processor 830 may determine a result of receiving the control signal and the data signal transmitted by the terminal.

In particular, it is envisaged that the aforementioned inventive concept can be applied by a semiconductor manufacturer to any integrated circuit comprising a signal processor operable to perform any of the aforementioned operations. Furthermore, the inventive concept can be applied to any circuit that is able to configure, process, encode and/or decode signals for wireless distribution. It is further envisaged that, for example, a semiconductor manufacturer may employ the inventive concept in a design of a stand-alone device, such as a digital signal processor, or application-specific integrated circuit (ASIC) and/or any other sub-system element.

It will be appreciated that, for clarity purposes, the above description has described example embodiments with reference to different functional units and processors. However, it will be apparent that any suitable distribution of functionality between different functional units or processors, for example with respect to the signal processor may be used without detracting from the concepts described herein. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects may be implemented in any suitable form including hardware, software, firmware or any combination of these. Example embodiments may optionally be implemented, at least partly, as computer software running on one or more data processors and/or digital signal processors or configurable circuit components such as FPGA devices. Thus, the elements and components of an embodiment may be physically, functionally and logically implemented in any suitable way. Indeed, the functionality may be implemented in a single unit, in a plurality of units or as part of other functional units.

Although the concepts have been described in connection with some embodiments, it is not intended to be limited to the specific form set forth herein. Rather, the scope is limited only by the accompanying claims. Additionally, although a feature may appear to be described in connection with particular embodiments, one skilled in the art would recognize that various features of the described embodiments may be combined in other examples. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

In accordance with examples herein described, a number of approaches are provided to enable better access to RAN data, wherein the aforementioned disadvantages with prior art arrangements have been substantially alleviated.

### REFERENCES

[1] 3GPP TS 23.288, “Architecture enhancements for 5G System (5GS) to support network data analytics services” V18.0.0, December 2022.
[2] 3GPP TR 23.700, “Study on enablers for network automation for the 5G System (5GS)” V17.0.0, December 2020.
[3] 3GPP TS 37.320, “Radio measurement collection for Minimization of Drive Tests (MDT); Overall description;”, V17.2.0, December 2022.
[4] 3GPP TS 28.104, “Management and orchestration; Management Data Analytics (MDA)”, V17.2.0, December 2022.
[5] 3GPP TS 38.331, “NR; Radio Resource Control (RRC) protocol specification”, V17.3.0, December 2022.
[6] 3GPP TS 28.552, “5G performance measurements”, V18.1.0, December 2022.

1. A user equipment (UE) in a wireless communication system, the UE comprising:
a transceiver; and
a controller coupled to the transceiver, and configured to:
receive, from a base station, configuration information configuring a radio resource control (RRC) connected state measurement,
perform the RRC connected state measurement,
store a set of RRC connected state measurements based on the RRC connected state measurement for a period of time, and in case that a triggering event is identified, transmit, to the base station, the set of the RRC connected state measurements.

2. The UE of claim 1, wherein the configuration information includes at least one of a logging interval, a measurement duration, a flag indicating which measurements to be logged, or a reporting criteria.

3. The UE of claim 2,
wherein the triggering event is determined based on the reporting criteria, and
wherein the reporting criteria is based on a reference signal received power (RSRP) of a serving cell or a neighbouring cell.

4. The UE of claim 1, wherein the set of the RRC connected state measurements are transmitted periodically or in response to a request by the base station.

5. A base station in a wireless communication system, the base station comprising:
a transceiver; and
a controller coupled to the transceiver, and configured to:
transmit, to a user equipment (UE), configuration information configuring a radio resource control (RRC) connected state measurement,
in case that a triggering event is identified, receive, from the UE, a set of the RRC connected state measurements,
wherein the set of RRC connected state measurements is based on a RRC connected state measurement for a period of time.

6. The base station of claim 5, wherein the configuration information includes at least one of a logging interval, a measurement duration, a flag indicating which measurements to be logged, or a reporting criteria.

7. The base station of claim 6,
wherein the triggering event is determined based on the reporting criteria, and
wherein the reporting criteria is based on a reference signal received power (RSRP) of a serving cell or a neighbouring cell.

8. The base station of claim 5, wherein the set of the RRC connected state measurements are received periodically or in response to a request by the base station.

9. A method performed by a user equipment (UE) in a wireless communication system, the method comprising:
receiving, from a base station, configuration information configuring a radio resource control (RRC) connected state measurement;
performing the RRC connected state measurement;
storing a set of RRC connected state measurements based on the RRC connected state measurement for a period of time, and in case that a triggering event is identified, transmitting, to the base station, the set of the RRC connected state measurements.

10. The method of claim 9, wherein the configuration information includes at least one of a logging interval, a measurement duration, a flag indicating which measurements to be logged, or a reporting criteria.

11. The method of claim 10,
wherein the triggering event is determined based on the reporting criteria, and
wherein the reporting criteria is based on a reference signal received power (RSRP) of a serving cell or a neighbouring cell.

12. The method of claim 9, wherein the set of the RRC connected state measurements are transmitted periodically or in response to a request by the base station.

13. A method performed by a base station in a wireless communication system, the method comprising:
transmitting, to a user equipment (UE), configuration information configuring a radio resource control (RRC) connected state measurement;
in case that a triggering event is identified, receiving, from the UE, a set of the RRC connected state measurements,
wherein the set of RRC connected state measurements is based on a RRC connected state measurement for a period of time.

14. The method of claim 13, wherein the configuration information includes at least one of a logging interval, a measurement duration, a flag indicating which measurements to be logged, or a reporting criteria.

15. The method of claim 14,
wherein the triggering event is determined based on the reporting criteria, and
wherein the reporting criteria is based on a reference signal received power (RSRP) of a serving cell or a neighbouring cell.
